(19) United States
(12) Patent Application Publication
(10) Pub. No.: US 2026/0268808 A1
(43) Pub. Date: Sep. 10, 2026

(54) HANG TAG

(71) Applicant: THE IMAGINE GROUP, LLC, Shakopee, MN (US)

(72) Inventor: Mark Richard Popp, Jordan, MN (US)

(21) Appl. No.: 19/559,339

(22) Filed: Mar. 6, 2026

Related U.S. Application Data
(60) Provisional application No. 63/768,791, filed on Mar. 7, 2025.
(60) Provisional application No. 63/964,271, filed on Jan. 20, 2026.

(51) Int. Cl. G09F 7/18

(52) U.S. Cl. CPC G09F 7/18

(57) ABSTRACT

A novel and advantageous hang tag for use with signs, such as signs in a retail environment is provided. Particularly, a hang tag that can removably attach a sign to a support structure without obstructing view of information on the support structure and without requiring hardware is provided. The hang tag may have a carrier film and adhesive applied to the carrier film. The carrier film may have a first surface and a second surface. A first adhesive may be applied to a portion of the first surface and a second adhesive may be applied to a portion of a second surface where the first surface portion and the second surface portion do not mirror one another. For example, the first surface portion may be an upper portion of the hang tag and the second surface portion may be a lower portion of the hang tag. The hang tag may be used for attractive, inexpensive, temporary signage.

### CROSS-REFERENCE TO RELATED APPLICATIONS

This application claims the benefit of and priority to United States Provisional Patent Applications Serial Nos. 63/768,791 filed Mar. 7, 2025, and 63/964,271 filed Jan. 20, 2026, the disclosures of each of which are herein incorporated by reference in their entireties.

### FIELD OF THE INVENTION

The present disclosure relates to a novel and advantageous hang tag for use with signs, such as signs in a retail environment. Particularly, the present disclosure relates to a novel and advantageous hang tag that can removably attach a sign to a support structure without obstructing view of information on the support structure and without requiring hardware. Even more particularly, the hang tag may comprise a carrier film with a first adhesive applied to a portion of a first surface of the carrier film and a second adhesive applied to a portion of a second surface of the carrier film, wherein the first surface portion and the second surface portion do not mirror one another. The hang tag may be used for attractive, inexpensive, temporary signage.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In retail environments, signs are frequently associated with products or specials. For example, a promotional sign may be used as a short term indicator for a specific promotion. Such promotional sign may be attached to a support structure such as a shelf, fixture, display, or the like for the duration of the promotion. When the promotion is over the sign is removed. Such signage may be referred to as temporary signage.

Commonly, hardware is required to hang temporary signage. Such hardware is a cost and also limits the amount of temporary signage that can be hung (limited to the amount of hardware that is available). Further, hardware can become scratched or cracked or generally deteriorate in attractiveness.

There is a need in the art for a sign, sign holder, or sign attachment device that is sufficiently secure to stay attached to a support structure, can be removed from the support structure without damaging the support structure, that can be viewed without obstructing view of information on the support structure, and that is inexpensive and does not require stored inventory.

### SUMMARY

In one aspect, the present disclosure provides a sign for attaching to a support structure, the sign comprising: a forward facing surface configured for displaying information and a rearward facing surface opposed to the forward facing surface; and a hang tag coupled to the rearward facing surface and extending along at least a portion of a perimeter edge of the sign, the hang tag comprising; an upper portion having a front surface and a back surface; and a lower portion having a front surface and a back surface, wherein a permanent adhesive is provided on the lower portion front surface and a removable adhesive is provided on the upper portion back surface, and wherein the permanent adhesive affixes the hang tag to the rearward facing surface.

In another aspect, the present disclosure provides a hang tag comprising an upper portion having a front surface and a back surface; and a lower portion having a front surface and a back surface, wherein a permanent adhesive is provided on the lower portion front surface and a removable adhesive is provided on the upper portion back surface, and wherein the permanent adhesive affixes the hang tag to the rearward facing surface.

In yet another aspect, the present disclosure provides a sign holder comprising a body having a forward facing surface and a rearward facing surface; and a hang tag, wherein the hang tag comprises: an upper portion having a front surface and a back surface; and a lower portion having a front surface and a back surface, wherein a permanent adhesive is provided on the lower portion front surface and a removable adhesive is provided on the upper portion back surface.

In yet another aspect, the present disclosure provides a method for securing a sign to a support structure, the method comprising: providing sign including a forward facing surface configured for displaying information and a rearward facing surface opposed to the forward facing surface; providing a hang tag configured to couple to the rearward facing surface and extend along at least a portion of a perimeter edge of the sign, the hang tag comprising; an upper portion having a front surface and a back surface; and a lower portion having a front surface and a back surface, wherein a permanent adhesive is provided on the lower portion front surface and a removable adhesive is provided on the upper portion back surface; and affixing the hang tag to the rearward facing surface; and affixing the removable adhesive to the support structure.

In yet another aspect, the present disclosure provides a method for securing a sign to a support structure, the method comprising: providing sign including a forward facing surface configured for displaying information and a rearward facing surface opposed to the forward facing surface; providing a hang tag configured to couple to the rearward facing surface and extend along at least a portion of a perimeter edge of the sign, the hang tag comprising; an upper portion having a front surface and a back surface; and a lower portion having a front surface and a back surface, wherein a permanent adhesive is provided on the lower portion front surface and a removable adhesive is provided on the upper portion back surface; and affixing the hang tag to the rearward facing surface; and affixing the removable adhesive to the support structure.

In yet another aspect, the present disclosure provides a method for securing a sign to a support structure, the method comprising: providing sign including a forward facing surface configured for displaying information and a rearward facing surface opposed to the forward facing surface; providing a hang tag coupled to the rearward facing surface and extending along at least a portion of a perimeter edge of the sign, the hang tag comprising; an upper portion having a front surface and a back surface; and a lower portion having a front surface and a back surface, wherein a permanent adhesive is provided on the lower portion front surface and a removable adhesive is provided on the upper portion back surface; optionally removing a release liner from the removable adhesive; and affixing the removable adhesive to the support structure.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1A illustrates a rear view of a hang tag, in accordance with one embodiment.

FIG. 1B illustrates an end view of the hang tag of FIG. 1A.

FIG. 2 illustrates a front view of a sign with a hang tag adhered thereto, in accordance with one embodiment.

FIG. 3 illustrates a rail strip on which the sign may be adhered.

FIG. 4 illustrates a sign with hang tag attached thereto, the upper portion of the hang tag being aligned with the rail strip, in accordance with one embodiment.

FIG. 5 illustrates a user removing the liner from the upper portion of the back surface of the hang tag, in accordance with one embodiment.

FIG. 6 illustrates a sign holder according to embodiments of the disclosure.

### DETAILED DESCRIPTION

The present disclosure relates to a novel and advantageous hang tag for use with signs, such as signs in a retail environment. Particularly, the present disclosure relates to a novel and advantageous hang tag that can removably attach a sign to a support structure without obstructing view of information on the support structure and without requiring hardware. Even more particularly, the hang tag may comprise a carrier film with a first adhesive applied to a portion of a first surface of the carrier film and a second adhesive applied to a portion of a second surface of the carrier film, wherein the first surface portion and the second surface portion do not mirror one another. For example, the first surface portion may be an upper portion of the hang tag and the second surface portion may be a lower portion of the hang tag. The hang tag may be used for attractive, inexpensive, temporary signage.

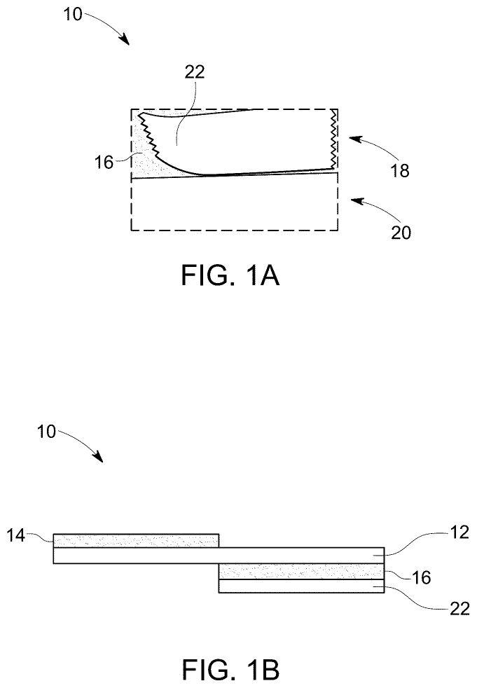

FIG. 1A illustrates a rear view of a hang tag 10, in accordance with one embodiment. FIG. 1B illustrates an end view of the hang tag 10 of FIG. 1A. The hang tag comprises a carrier film 12, also referred to as a backing, with an adhesive 14, 16 applied to each major surface, 13a, 13b of the backing 12.

The hang tag 10 has a front surface 13a and a back surface 13b, an upper portion 18 and a lower portion 20. In the embodiment shown, the lower portion 20 of the front surface 13a has an adhesive 14 applied thereto. The upper portion 18 of the back surface 13b has an adhesive 16 applied thereto. It is to be appreciated that the adhesive 16 on the back surface 13b is applied to only a portion of the back surface 13b, such as the upper half of the back surface 13b and the adhesive 14 on the front surface 13a is applied to only a portion of the front surface 13a, such as the lower half of the front surface 13a. The front surface adhesive 14 and the back surface adhesive 16 may be the same type of adhesive or may be different. In one embodiment, the front surface adhesive 14, referred to herein as a permanent adhesive, provides permanent adhesion and the back surface adhesive 16, referred to herein as a removable adhesive, provides removable adhesion.

In the embodiment shown, adhesive 14, 16 is applied to a region on a front surface of backing 12 and a region on the back major surface of backing 12, wherein the areas do not mirror one another. In some embodiments, this results in no overlap in planes orthogonal to the major surface 13a, 13b. In other embodiments, slight or substantial overlap in the regions is permissible.

In the same or other embodiments, the back surface adhesive 16 region may cover greater or less than 50% of the back surface area. In some embodiments, substantially the entire back surface area is included within the adhesive region. In other embodiments, no greater than 45%, no greater than 30%, no greater than 20%, or less than 10% of the back surface is included within the adhesive region. In presently preferred circumstances, the back surface adhesive region comprises no greater than 60% of the back surface area.

In the same or other embodiments, the front surface adhesive 14 region may be greater or less than 50% of the front surface area. In some embodiments, substantially the entire front surface area is included within the adhesive region. In other embodiments, no greater than 40%, no greater than 30%, no greater than 20%, or less than 10% of the front surface area is included within the front surface adhesive region. In presently preferred circumstances, the front surface adhesive region comprises no greater than 60% of the front surface area.

Adhesives 14, 16 may be discontinuous (e.g., pattern coated) across the front surface 13a, the back surface 13b, or both.

The back surface adhesive 16 may be covered with a removable liner 22. While a half width (covering half of the back surface) liner is shown, in some embodiments, a full width liner may be used. Further, in some embodiments, the liner 22 may be an extended liner, wherein a portion of the liner 22 extends past the adhesive 16 provided on the back surface 13b such that the liner 22 is easy to grip. The liner 22 may comprise any suitable material. The liner 22 should adhere to the adhesive 16 but be easily lifted from the adhesive 16 without degrading the integrity of the adhesive. In some embodiments, the liner 22 may be clear or opaque, paper, plastic, etc., and may be coated with release agents such as fluorosilicones. It may be useful for the liner 22 to be opaque in order to be more visible to a user for removal.

The hang tag backing 12 may comprise any suitable material. In general, it may be desirable that the backing 12 comprise a material that is transparent and that has sufficient strength to not tear when supporting a sign. Some examples of material that may be used for the hang tag backing include a plastic such as polypropylene (PP) (mono-oriented (MOPP) or biaxially-oriented (BOPP)), polyethylene (PE), and polyester (polyethylene terephthalate (PET)). In some embodiments, the hang tag backing 12 may have a thickness of about 1.2 mils (~0.03 mm).

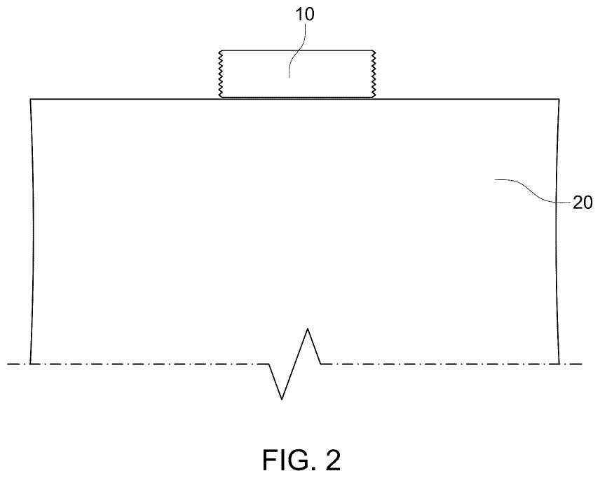

FIG. 2 illustrates a rear view of a sign 26 with a hang tag 10 affixed thereto. The sign 26 may have a forward facing surface configured for displaying information. The forward facing surface of the sign may be printed with information. The lower portion 20 of the hang tag is fixed to the rearward facing surface of the sign. The hang tag 10 may be affixed to the sign at a print facility. The upper portion 18 of the hang tag removably affixes to a support structure, such as a rail strip, shelf, fixture, display, etc. The upper portion 18 of the hang tag 10 may be transparent such that it does not obstruct view of the support structure or information displayed on the support structure.

The sign may be comprised of a material that is inexpensive but has an attractive appearance and some level of integrity. In various embodiments, the sign 26 may comprise boardstock, paper, plastic (e.g., styrene, polypropylene, etc.), 8 pt Solid Bleached Sulfate (SBS), or similar material.

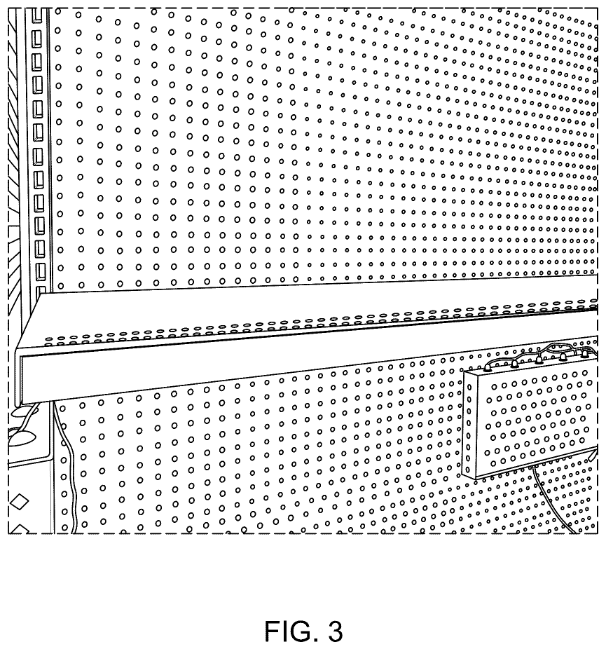

FIG. 3 illustrates a rail strip 28 on which a sign may be adhered using a hang tag 10, for example during an advertising campaign.

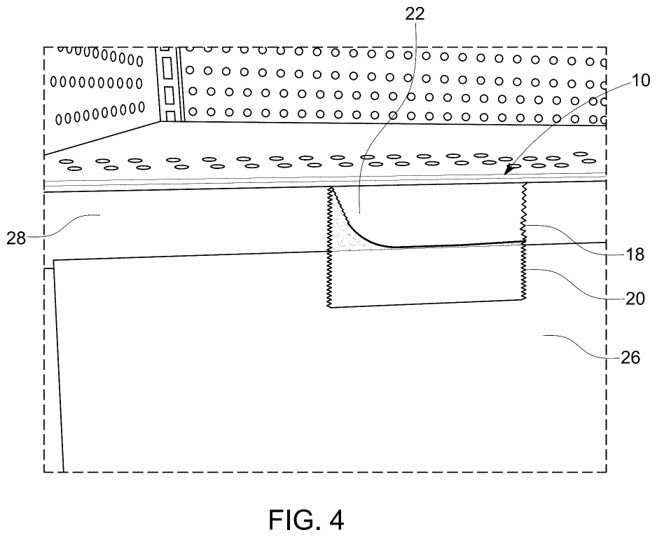

FIG. 4 illustrates a sign 26 with a hang tag 10 attached thereto, the upper portion 18 of the hang tag being aligned with the rail strip 28. It is to be appreciated that FIG. 4 illustrates the sign 26 and hang tag 10 flipped from ordinary usage so that the entire hang tag, and its orientation, is visible. As shown, the upper portion 18 of the hang tag 10 is aligned with the rail strip 28 while the lower portion 20 of the hang tag is affixed to the sign 26. A liner 22 is provided over adhesive on the upper portion of the hang tag. In use, the liner 22 is removed, exposing the adhesive on the upper portion of the back surface of the hang tag, and the upper portion of the back surface of the hang tag is pressed against the rail strip to removably adhere the hang tag to the rail strip. Because the upper portion of the hang tag is substantially transparent, view of the rail strip and information displayed on the rail strip is not obstructed. Such information may include, for example, information about a product to be placed on the shelf, including a bar code, language about a product being sold (such as name and/or regular price), SKU, or other. The rear portion of the hang tag is covered by the sign and is not viewable when the sign is in place on the rail strip. It is to be appreciated that while a rail strip is discussed as a support structure in FIG. 3, the hang tag may be used to affix a sign to any suitable support structure.

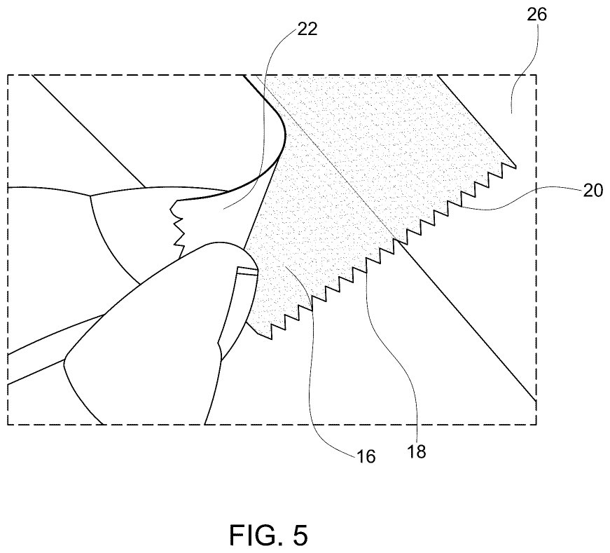

FIG. 5 illustrates a user removing a liner 22 from the upper portion 18 of the back surface of the hang tag 10. To display a sign 26, the user removes the liner 22 and presses the upper portion 18 of the back surface of the hang tag 10 against a support structure. When the sign is no longer needed, a user pulls the hang tag 10 from the support structure.

The adhesives used herein may vary and may be selected for specific uses. More particularly, each of the formulation of the adhesive and the coat weight of the adhesive may be selected. In general, the removable adhesive can be selected based on the material it is being adhered to and the weight it will be supporting. In various applications, the support structure may be corrugated cardboard, metal, glass, or plastic and may have a smooth surface or a rough surface. In use on the hang tag, the removable adhesive adheres the sign to a support structure and holds the sign on the support structure until it is manually removed. The adhesive thus must adhere to the surface of the support structure but also be able to be removed from the surface without damaging the surface. Suitable permanent and removable adhesives include acrylic pressure sensitive adhesives, available from 3M Company, St. Paul, MN. Thickness of the adhesive on either side is not particularly limited.

The size of the hang tag may be selected based on use. In general, the size of the hang tag may correlate to the sizing of the support structure to which a sign is to be applied and/or to size and weight of the sign it will hold. In one embodiment, the sign is 7 inches by 8 inches and the hang tag is 2 inches by 3 inches, with a rail strip having a height of approximately 1 inch. The length of the hang tag relative to the length of the sign is not particularly limited. In other embodiments, the length of the hang tag may be about 7 inches such that it extends across substantially the entire top edge of a 7 inch by 8 inch sign. In yet other embodiments, a plurality of hang tags of the type described herein may be adhered to the sign.

The upper portion and the lower portion of the hang tag may be equally sized, such as 1 inch by 1 inch in the example discussed. Alternatively, the upper portion and the lower portion of the hang tag may have different sizes, such as the upper portion being 0.75 inch by 1.5 inch and the lower portion being 1.25 inch by 1.5 inch.

While the hang tag is shown applied to a flat, linear sign and a flat, linear surface, it is to be appreciated that the hang tag may be flexible and can conform to a wide variety of surfaces, including curved surfaces.

Hang tags may be provided on a spool or roll for industrial usage. More specifically, a company in the business of printing signs may print signs for a client and apply a hang tag to each sign at the print facility. In such embodiment, the hang tag is cut to size and the front surface lower portion pressed to the sign, with the back surface upper portion having a liner provided over an adhesive thereon. Cutting and/or application of the hang tag may be automated. With the back surface adhesive protected by a liner, the sign with hang tag attached thereto may be shipped to a client (or any other facility).

Alternatively, in some embodiments, precut hang tags, or hang tags removed from a spool of hang tags, may be applied by a retailer directly before hanging of a sign. In such embodiments, a liner may not be provided.

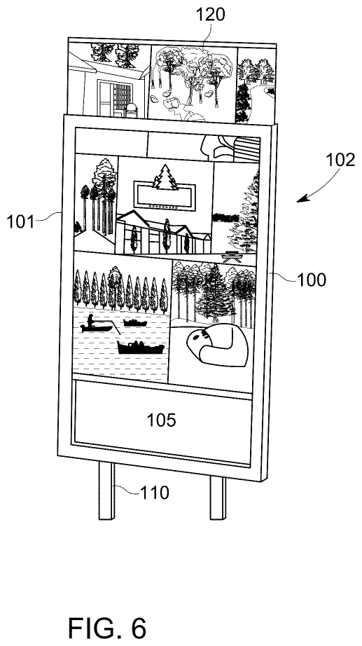

In other embodiments, as depicted in FIG. 6, a sign holder comprising a frame 100 and a support structure 110 may be provided. The frame 100 may be configured for receiving a sign 120, and optionally panes of material (e.g., glass or transparent plastic). The frame 100 may have forward facing surfaces 101 and a rearward facing support surfaces 102. The interior of the frame 100 may be open or transparent, and a space for receiving the sign 120 and any optional panes may be provided between the forward facing surfaces 101 and the rearward facing surfaces 102 of the frame 100.

A sign 120 can be attached to or received in the sign holder using the hang tags of the present disclosure, either within the interior 105 of frame 100 or to obscure another sign already received in the frame 100 interior. The lower portion of a hang tag, such as hang tag 10, can be fixed to the rear of the sign. The upper portion of the hang tag removably affixes to a surface of the frame 100 or the existing sign. The upper portion of the hang tag may be transparent such that it does not obstruct view of the frame or information displayed on the frame.

In an embodiment including a sign holder, a sign may be inserted into the sign holder for use in an advertising campaign. The sign holder may be removed from the support structure and the sign removed. The sign can be replaced with a sign for a different advertising campaign and the sign holder fixed to a new support structure. Alternatively, the sign holder may be left in place with the sign replaced with or obscured by a different sign.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A hang tag for use with signs, the hang tag comprising:
an upper portion having a front surface and a back surface; and
a lower portion having a front surface and a back surface;
wherein a permanent adhesive is provided on the lower portion front surface and a removable adhesive is provided on the upper portion back surface.

2. The hang tag of claim 1, further comprising a liner provided over the removable adhesive.

3. The hang tag of claim 2, wherein the liner is an extended liner and extends along the back surface beyond the removable adhesive.

4. The hang tag of claim 1, wherein the upper portion is transparent.

5. The hang tag of claim 1, wherein the permanent adhesive defines a first adhesive region on the front surface, wherein the removable adhesive defines a second adhesive region on the back surface, and wherein the first adhesive region does not substantially overlap with the second adhesive region in planes orthogonal to the back surface.

6. The hang tag of claim 1, wherein the removable adhesive defines an adhesive region on the back surface, and wherein the adhesive region comprises no greater than 60% of a total area of the back surface.

7. The hang tag of claim 6, wherein the removable adhesive comprises no greater than 30% of the total area.

8. The hang tag of claim 1, wherein at least one of the permanent adhesive and removable adhesive is discontinuous.

9. The hang tag of claim 1, wherein the permanent adhesive defines an adhesive region on the front surface, and wherein the adhesive region comprises no greater than 60% of a total area of the front surface.

10. The hang tag of claim 1, wherein the hang tag comprises a backing, and wherein the backing has a thickness of about 0.03 mm.

11. A sign for attaching to a support structure, the sign comprising:
a forward facing surface configured for displaying information and a rearward facing surface opposed to the forward facing surface;
a hang tag coupled to the rearward facing surface and extending along at least a portion of a perimeter edge of the sign, the hang tag comprising;
an upper portion having a front surface and a back surface; and
a lower portion having a front surface and a back surface;
wherein a permanent adhesive is provided on the lower portion front surface and a removable adhesive is provided on the upper portion back surface,
and wherein the permanent adhesive affixes the hang tag to the rearward facing surface.

12. The sign of claim 11, and further comprising a liner provided over the removable adhesive.

13. The sign of claim 11, wherein the removable adhesive defines an adhesive region on the back surface, and wherein the adhesive region comprises no greater than 60% of a total area of the back surface.

14. The sign of claim 11, wherein the permanent adhesive defines a first adhesive region on the front surface, wherein the removable adhesive defines a second adhesive region on the back surface, and wherein the first adhesive region does not substantially overlap with the second adhesive region in planes orthogonal to the back surface.

15. The sign of claim 11, wherein the hang tag is a first hang tag, the sign further comprising a second hang tag coupled to the rearward facing surface and extending along a different portion of the perimeter edge than the first hang tag, the second hang tag comprising;
an upper portion having a front surface and a back surface; and
a lower portion having a front surface and a back surface;
wherein a permanent adhesive is provided on the lower portion front surface of the second hang tag and a removable adhesive is provided on the upper portion back surface of the second hang tag.

16. A sign holder, the sign holder comprising:
a body having a forward facing surface and a rearward facing surface;
a hang tag, wherein the hang tag comprises:
an upper portion having a front surface and a back surface; and
a lower portion having a front surface and a back surface;
wherein a permanent adhesive is provided on the lower portion front surface and a removable adhesive is provided on the upper portion back surface.

17. The sign holder of claim 16, further comprising a liner provided over the removable adhesive.

18. The sign holder of claim 17, wherein the liner is an extended liner and extends along the back surface beyond the removable adhesive.

19. The sign holder of claim 16, wherein the upper portion of the hang tag is transparent.

20. The sign holder of claim 16, wherein a space is provided between the forward facing surface and the rearward facing surface of the body and wherein the space is configured for receiving a sign.
